(19) United States
(12) Patent Application Publication
(10) Pub. No.: US 2025/0190374 A1
(43) Pub. Date: Jun. 12, 2025

(54) PRESETTING THE MEMORY PROTECTION KEY IN DEDICATED MEMORY

(71) Applicant: INTERNATIONAL BUSINESS MACHINES CORPORATION, ARMONK, NY (US)

(72) Inventor: HARRIS M. MORGENSTERN, WAPPINGERS FALLS, NY (US)

(21) Appl. No.: 18/536,336

(22) Filed: Dec. 12, 2023

(51) Int. Cl. G06F 12/14; G06F 9/50

(52) U.S. Cl. CPC G06F 12/1441; G06F 9/5016; G06F 12/1466

(57) ABSTRACT

Presetting the memory protection key in dedicated memory is disclosed, including assigning, by a memory manager to a program, based on configuration information, one or more units of dedicated memory from a pool of dedicated memory, wherein the one or more units of dedicated memory is reserved for the program until program completion; and setting, by the memory manager based on the configuration information, a memory protection key for each frame in the one or more units of dedicated memory assigned to the program.

### BACKGROUND

The present disclosure relates to methods, apparatus, and products for presetting the memory protection key in dedicated memory.

Typically, when an application stores into or otherwise uses virtual memory, real memory is used to back the virtual memory. Real memory is returned to the system when either the application frees the virtual memory it is backing or the operating system reclaims the real storage by way of paging it to auxiliary memory or storage. This model does not provide exclusive use to an area of memory that can endure until program completion and therefore the program must compete with other applications for memory with every frame allocation. Memory protection keys are used to limit access to memory utilized by a program. Typically, the memory protection key for a frame or unit of memory is set when the program request memory because the operating system does not know in advance which frames of memory will be used by a program. Setting the memory protection key at the time of memory allocation increases the number of processor cycles consumed by memory allocation.

### SUMMARY

According to embodiments of the present disclosure, various methods, apparatus and products for presetting the memory protection key in dedicated memory are described herein. In some aspects, presetting the memory protection key in dedicated memory includes assigning, to a program based on configuration information, one or more units of dedicated memory from a pool of dedicated memory, where the units of dedicated memory are reserved for the program until program completion. Presetting the memory protection key in dedicated memory also includes setting, based on the configuration information, a memory protection key for each frame in the units of dedicated memory assigned to the program.

### BRIEF DESCRIPTION OF THE DRAWINGS

FIG. 1 sets forth a block diagram of an example computing system configured for presetting the memory protection key in dedicated memory in accordance with embodiments of the present disclosure.

FIG. 2 sets forth a flowchart of an example method for presetting the memory protection key in dedicated memory in accordance with at least one embodiment of the present disclosure.

FIG. 3A sets forth a block diagram of an example memory configuration for presetting the memory protection key in dedicated memory in accordance with at least one embodiment of the present disclosure.

FIG. 3B sets forth a block diagram of an example memory configuration for presetting the memory protection key in dedicated memory in accordance with at least one embodiment of the present disclosure.

FIG. 4 sets forth a flowchart of an example method for presetting the memory protection key in dedicated memory in accordance with at least one embodiment of the present disclosure.

FIG. 5 sets forth a flowchart of an example method for presetting the memory protection key in dedicated memory in accordance with at least one embodiment of the present disclosure.

### DETAILED DESCRIPTION

Real memory is typically managed by the operating system using the demand paging model; namely, when an application stores into or otherwise uses virtual memory, real memory is used to back the virtual memory. Real memory is returned to the system when either the application frees the virtual memory it is backing or the operating system reclaims the real storage by way of paging it to auxiliary memory or storage. This scheme presents drawbacks in that it makes no distinction between the applications competing for memory as memory is assigned on a first come first serve basis, and it makes no distinction between applications whose frames are selected for paging.

Some applications have irregular or unpredictable memory requirements and perform better when they are assigned real memory before starting, thus avoiding competition with other applications for memory. One such application is an operating system dump capture, which typically occurs unexpectedly when some system error occurs. Operating system dumps can preempt existing work in the system and thus it is beneficial to minimize the duration of the dump capture time. If the system is short of frames when the dump capture is initiated, capture time will increase since the system will need to steal frames from other applications, which is a very time-consuming process.

Dedicated memory provides a mechanism for part of the total memory of a system to be designated as dedicated memory, effectively reserving memory for the exclusive use of a set of selected applications. The system administrator can select applications at the job step level where a job step is a program in execution and a job includes one or more sequential job steps. Once the job step starts, the application uses dedicated memory transparently. Page faults or other requests for real memory are satisfied from the dedicated memory pool if available and from a global pool of shared memory if not.

When a request for real memory is fulfilled, the memory protection key for each frame is set to match that of the program requesting memory. Setting the memory protection key is an expensive operation in terms of the number of processor cycles consumed by the operation. Clearing the frame (i.e., setting all bits to zero) is another expensive operation.

Embodiments in accordance with the present disclosure provide a mechanism for setting the memory protection key at the time of dedicated memory assignment and before the program begins execution. Because the program that will use the frames of dedicated memory is known in advance based on the dedicated memory assignment, the memory protection key for these frames can also be set in advance, thus removing the performance penalty incurred by setting the memory protection key during program execution. Removing this performance penalty is particularly advantageous for programs with real time constraints. Similarly, the frames of dedicated memory can be cleared at the time of assignment, thus removing the performance penalty associated with clearing frames at the time of memory allocation.

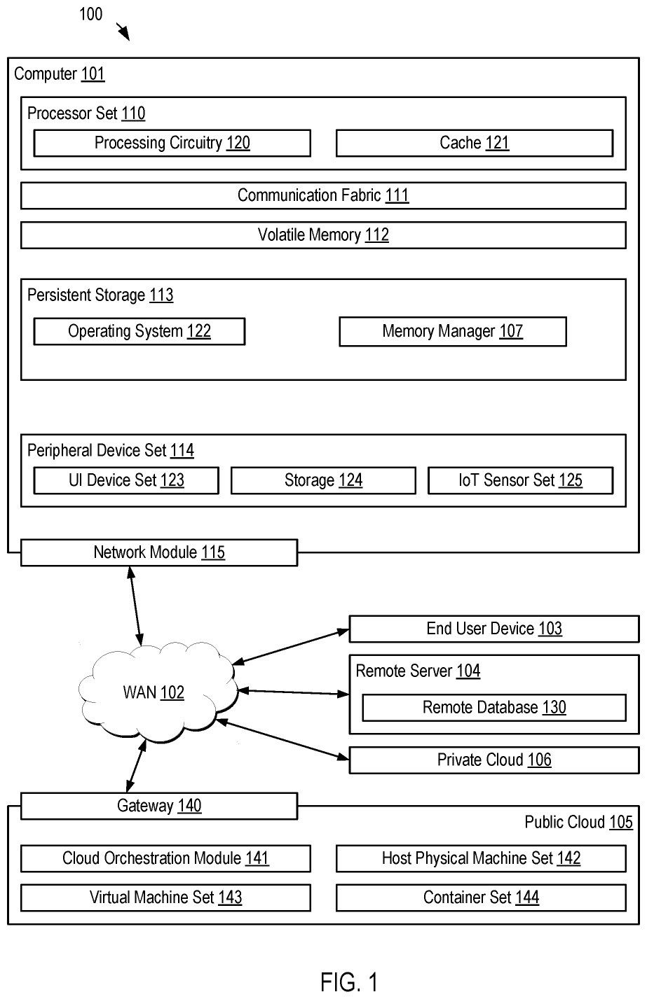

With reference now to FIG. 1, FIG. 1 sets forth an example computing environment according to aspects of the present disclosure. Computing environment 100 contains an example of an environment for the execution of at least some of the computer code involved in performing the various methods described herein, such as memory manager code 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

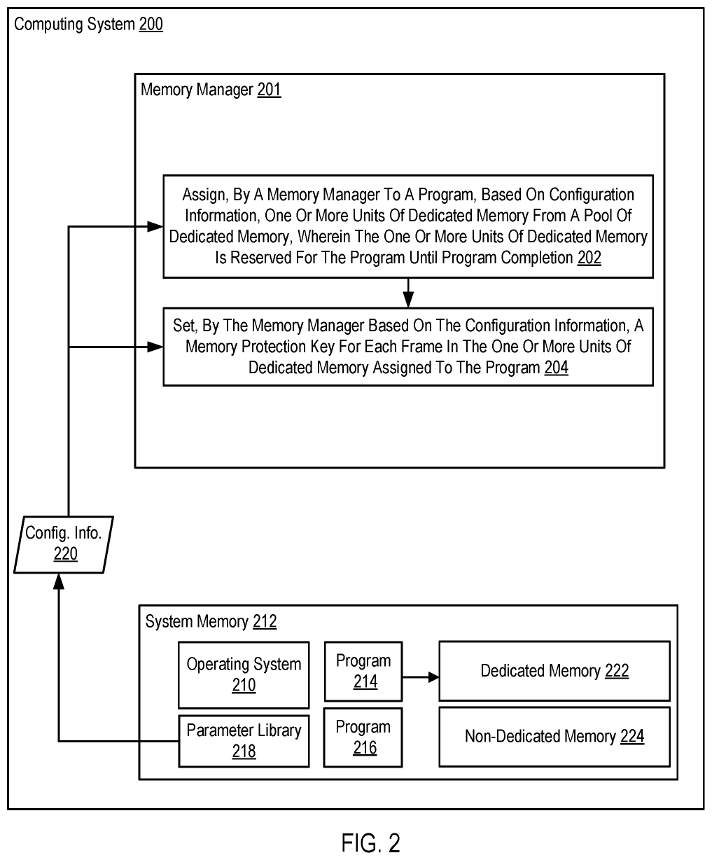

For further explanation, FIG. 2 sets forth a flowchart illustrating an example method of presetting the memory protection key in dedicated memory according to embodiments of the present disclosure. The example of FIG. 2 is described in the context of an example computing system 200 (e.g., the example computer 101 of FIG. 1). The example computing system 200 may be based on, for example, the z/Architecture offered by International Business Machines (IBM). Mainframe computing architectures, such as the z/Architecture, are particularly well-suited for the improvements described herein as such architectures typically involve multiple users or programs operating in multiple private address spaces concurrently, which requires more complex memory management. However, the use of such an architecture is provided only as one example for the computer system 200 and is not intended to limit the scope of the present disclosure. The computing system 200 includes an operating system 210 (e.g., the operating system 122 of FIG. 1) and a memory manager 201 configured to provide dedicated memory assignments to applications. In a particular example, the operating system 210 may be the z/OS operating system. The memory manager 201 may be a component of the operating system 210 or a separate module.

The example computing system 200 also includes one or more programs 214, 216. In some examples, the programs 214, 216 are applications embodied by a set of computer program instructions. In further examples, the programs 214, 216 are job step programs of the same job. For example, the operating system 210 may be configured to initiate a job by loading a job step program and, upon completion of that job step program, load the next job step program. This continues until the job completes.

The example computing system 200 also includes a parameter library 218 (e.g., the parmlib in the z/OS operating system) that includes configuration parameters for the programs 214, 216. For example, the configuration parameters for a program may include resources and resource limits for that program. In one example, a configuration parameter for a program may limit the amount of virtual memory utilized by the program. As will be explained in more detail below, a configuration parameter for a program may indicate an amount of dedicated memory the program and a memory protection key for dedicated memory assigned to the program. In some examples, the parameters in the parameter library 218 are configured by a user such as a system administrator. The parameter library 218 may be a file that is maintained and referenced by the operating system 210.

The example computing system 200 also includes system memory 212. The system memory 212 is comprised of real memory (e.g. physical RAM). The system memory 212 includes a system use area of memory (e.g., including operating system and system component address spaces) and a global pool of memory that is shared by applications or programs (i.e., shared memory). This global pool of shared memory is referred to herein as ‘non-dedicated memory.’ The non-dedicated memory 224 in the computing system 200 is subject to the drawbacks of conventional memory management mechanisms. That is, memory requests (e.g., page faults) as satisfied on a first come first served basis and programs may be forced to wait for such requests to be satisfied, for example, during memory usage spikes. In the demand paging model, for example, when a program uses virtual memory, real memory is used to back the virtual memory. Real memory is returned to the system when either the program frees the virtual memory it is backing or the operating system reclaims the real memory by way of paging it to auxiliary storage. Such a model makes no distinction between the applications competing for memory and makes no distinction between programs whose frames are selected for paging.

Programs may also be forced to wait for memory requests to be satisfied because the memory protection key must be set for each frame of real memory that is allocated as a result of the request. The memory protection key ensures that a program can only write to the allocated memory (or read the allocated memory if it is fetch-protected) if the memory protection key matches a program key. In a particular example, the z/Architecture the information in system memory is protected from unauthorized use by means of multiple protection keys. A control field in storage called a key is associated with each 4 kilobyte (KB) frame of system memory. When a request is made to modify the contents of a system memory location, the program key associated with the request is compared to the memory protection key. If the keys match or the program is executing in key 0, the request is satisfied. If the key associated with the request does not match the memory protection key, the system rejects the request and issues a program exception interruption. When a request is made to read (or fetch) the contents of a system memory location, the request is automatically satisfied unless the fetch protect bit is on, indicating that the frame is fetch-protected. When a request is made to access the contents of a fetch-protected system memory location, the memory protection key is compared to the program key associated with the request. If the keys match, or the requestor is in key 0, the request is satisfied. If the keys do not match, and the requestor is not in key 0, the system rejects the request and issues a program exception interruption.

There are 16 memory keys in z/OS. A specific key is assigned according to the type of work being performed. The key is stored in bits 8 through 11 of the program status word (PSW). A PSW is assigned to each job in the system. Memory protection keys 0 through 7 are used by the z/OS base control program (BCP) and various subsystems and middleware products. Memory protection key 0 is the master key. Its use is restricted to those parts of the BCP that require almost unlimited store and fetch capabilities. In almost any situation, a storage protect key of 0 associated with a request to access or modify the contents of a system memory location means that the request will be satisfied. Memory protection keys 8 through 15 are assigned to users. Users are isolated in private address spaces. Memory protection keys may be non-unique within the computing system 200 and operating system 210.

The instruction to set the memory protection key may consume considerable time. For programs with real time constraints, this amount of time is critical. In a particular example, a memory dump of a program address space may be carried out in response to the program ending abnormally (e.g., SVC dump in the z/Architecture). This memory dump can be used for diagnostic purposes. It is critical that the memory dump is captured as soon as possible before the address space is further changed to accurately reflect the program state at the time of the fault.

To address such issues, embodiments in accordance with the present disclosure provide dedicated memory 222 that, once dedicated memory has been assigned to a program, remains assigned to the program and is not freed until program completion. Thus, assigned dedicated memory remains in program control regardless of whether the program is utilizing all of the assigned dedicated memory. When a memory request is received from the program, the memory request is transparently fulfilled using dedicated memory assigned to the program if dedicated memory is available. To obviate the need to set the memory protection key during memory allocation and prevent the resulting lag time in fulfilling the request, the memory protection key is set at the time that the dedicated memory is assigned to the program. Thus, when the program requests memory and the requested memory is allocated from dedicated memory, the allocated frames are preset with the memory protection key.

In some examples, a memory manager 201 defines an area of dedicated memory 222 by first reading a dedicated memory configuration parameter that indicates how much dedicated memory to configure in the computing system 200. For example, the dedicated memory configuration parameter may be located in a parameter library such as the parameter library 218. The dedicated memory configuration parameter may be selected by a user through an interface that writes the dedicated memory configuration parameter, including the amount of dedicated memory to assign, to the parameter library. In some examples, the amount of dedicated memory is based on multiples of a particular frame size such as, for example, 2 gigabytes (GB), where that frame size is the increment by which dedicated memory is assigned. This frame size may also correspond to the largest page size supported by the operating system 210. Thus, the dedicated memory frame size is larger than the nominal real memory frame size (e.g., 4-KB).

In some examples, the amount of dedicated memory to define is based on historical memory usage of programs that will utilize dedicated memory. For example, the user can query the operating system 210 for system maintenance records or logs that indicate data regarding memory utilization of a program. Such data can include a high-water mark of the number of real storage frames (e.g., 4-KB frames) that are used to back 64-bit private memory, a high water mark of the number of auxiliary memory frames that are used to back 64-bit private memory, a high-water mark of the number of 2-GB frames used by a particular program, and the number of 2-GB frames that could not be obtained because none were available at the time of a memory allocation request. In the z/OS operating system, such information may be identified from system maintenance facility (SMF) records. The user can then identify a target dedicated memory allotment for each program and sum these amounts to select the total amount of dedicated memory to assign. In an alternative example, a script may be used to query memory usage records for a list of programs that will utilize dedicated memory and automatically generate recommended amounts of dedicated memory to assign to those programs. In such an example, the memory manager 201 may calculate an amount of dedicated memory to define. Once the user is aware of the dedicated memory that will be utilized by programs, the user can select an amount of dedicated memory to define on the system and store this number as the dedicated memory configuration parameter.

To aid illustration, consider an example using the z/OS operating system where the user analyzes historical memory usage statistics of critical applications using SMF records. The user then specifies, based on the historical analysis program dedicated memory parameters in the parmlib to indicate both target and minimum amounts of dedicated memory for specific job steps. The user also specifies, in the parmlib, the dedicated memory configuration parameter indicating the total amount of dedicated memory to define on the system based on which job steps are to be assigned dedicated memory. Upon the user starting the initial program load (IPL) (i.e., the operating system load), the memory manager requests system parameters from the parameter library and reads the dedicated memory configuration parameter. The memory manager then generates a dedicated memory configuration based on the dedicated memory configuration parameter and displays the memory configuration, giving the user the opportunity to respecify the parameters and/or redo the IPL.

In some examples, the user defines a target amount of dedicated memory and a minimum amount of dedicated memory for each program (e.g., job step) that will utilize dedicated memory. For example, the user may write this configuration information to a parameter library such as the parameter library 218. The configuration information may include the target amount and minimum amount of memory for the program. The memory manager 201 will use this configuration information when assigning dedicated memory to the program, first attempting to meet the target amount. In some examples, the program will not commence if the minimum amount of dedicated memory cannot be assigned; however, the minimum amount may also be specified as zero. The target amount and minimum amount of dedicated memory may be based on historical usage as discussed above.

In one example, during dedicated memory initialization, the memory manager 201 reads the parameter library specification of the amount of dedicated memory and reserves the specified amount of memory starting from the highest real memory address to descending addresses. This process may be performed prior to processing any other memory related parameters. It is possible that ranges within the dedicated memory area to be offline. Later in the system initialization process when multiple processors are brought online, the dedicated memory area is initialized and represented in a page frame table. This allows other components of the operating system, middleware and perhaps even applications, to initialize concurrently.

In one example, it is possible for an application that is eligible for a dedicated memory assignment initializes before dedicated memory is initialized. In such an example, the memory manager 201 is already aware how much dedicated memory will eventually be initialized. As such, it allows the application to initialize with less than the minimum required amount if the minimum amount could be satisfied once dedicated memory has completed initialization. However, the program that is initializing must wait for memory initialization to complete. In some examples, the operating system 210 provides a service that, when invoked by a program, polls to determine whether real memory has completed initialization and waits intermittently. After dedicated memory initialization is complete, the memory manager 201 determines whether any program that has already started has requested dedicated memory and whether the program's minimum dedicated memory has not been met. If the minimum has not been met, the memory manager 201 will assign at least enough dedicated memory to meet the minimum.

In view of the foregoing, the method of FIG. 2 includes assigning 202, by a memory manager 201 to a program 214, based on configuration information 220, one or more units of dedicated memory from a pool of dedicated memory, wherein the one or more units of dedicated memory is reserved for the program 214 until program completion. In some examples, the memory manager 201 assigns one or more units of dedicated memory by determining an amount of dedicated memory to assign to the program 214 based on the configuration information 220 for the program 214. In some implementations, when the operating system 210 initializes a program, the operating system 210 reads the parameter library to identify the configuration information 220 for the program. The configuration information 220 indicates the target amount of dedicated memory for the program and/or the minimum amount of dedicated memory for the program as well as the memory protection key that should be set for dedicated memory that is assigned to the program. The memory manager 201 determines how much dedicated memory can be assigned to the program based on these values and the available dedicated memory eligible for assignment. In some examples, the memory manager 201 will first determine whether the target amount of dedicated memory for the program can be satisfied. If the target amount can be satisfied, one or more units totaling the target amount is assigned to the program. If the target amount cannot be satisfied, the memory manager 201 will determine how much available dedicated memory can be assigned to the program such that the minimum amount of dedicated memory can be satisfied. If the minimum amount of dedicated memory cannot be assigned, the program is canceled and will not commence. Otherwise, all available dedicated memory be assigned to the program such that the amount of dedicated memory that is assigned is between the minimum amount and the target amount.

In some examples, the memory manager 201 assigns 202 units of dedicated memory to the program based on the determined amount of memory to be assigned. Once the portion of dedicated memory is assigned, the entire portion of assigned dedicated memory is available for use by the program and will not be freed until the program ends. For example, frames of dedicated memory cannot be ‘stolen’ or reallocated to a different program even if those frames are not in use by the program. The assignment of dedicated memory frames may be recorded, for example, in a page frame table. The portion of dedicated memory assigned can include both contiguous and noncontiguous frames. In some examples, when units of dedicated memory are assigned, each frame in the units of dedicated memory is cleared (e.g., all bits in the frame are set to ‘0’).

The method of FIG. 2 also includes setting 204, by the memory manager 201 based on the configuration information 220, a memory protection key for each frame in the one or more units of dedicated memory assigned to the program 214. In some examples, the memory manager 201 determines a memory protection key from a parameter in the configuration information 220 for the program that indicates a memory protection key and sets 204 the memory protection key for the assigned units of dedicated memory based on this parameter. In some implementations, the memory manager 201 sets 204 the memory protection key for each frame by recording the memory protection key in an entry for the frame in a page frame table or similar data structure. The memory protection key in the configuration information 220 indicates the program key with which the program 214 will execute. For example, the program key will be indicated in the PSW of the program 214. A user or operator can indicate this key as the memory protection key when providing the configuration information 220 to the computer system.

A variety of installations can benefit from dedicated memory including, for example, installations that are concerned about applications with irregular or unpredictable memory usage, such as operating system dump captures (e.g., SVC dump capture), installations that want to preferentially assign memory to certain applications that exploit high virtual storage (e.g., z/CX containers), and installations that want to exploit large amounts (e.g., greater than 4 TB) of memory (e.g., in-memory databases). Dedicated memory is useful in providing a program with guaranteed ownership of memory and is particularly suited for programs where the required amount of memory is fixed or readily estimated, such as containers (e.g., z/CX containers), and in-memory databases. For example, the memory used by containers may be a fixed size.

There may be additional considerations for using dedicated memory. In some z/OS operating system implementations, dedicated memory may be used transparently to back any private memory object as long as the memory object is freed at end of job step, i.e., owned by the job step task or a descendent. Thus, when dedicated memory is freed at the end of a step, the virtual memory that the dedicated memory backs must also be freed. Dedicated memory may be used transparently to back page tables of such memory objects. Dedicated memory may be used to back any private memory object if the address space is a single step started task (and also any dynamic address translation tables), such as DUMPSRV and z/CX containers on the z/OS platform. Dedicated memory is never paged/stolen as program owns the memory until end of job step, regardless of whether it actually uses the memory.

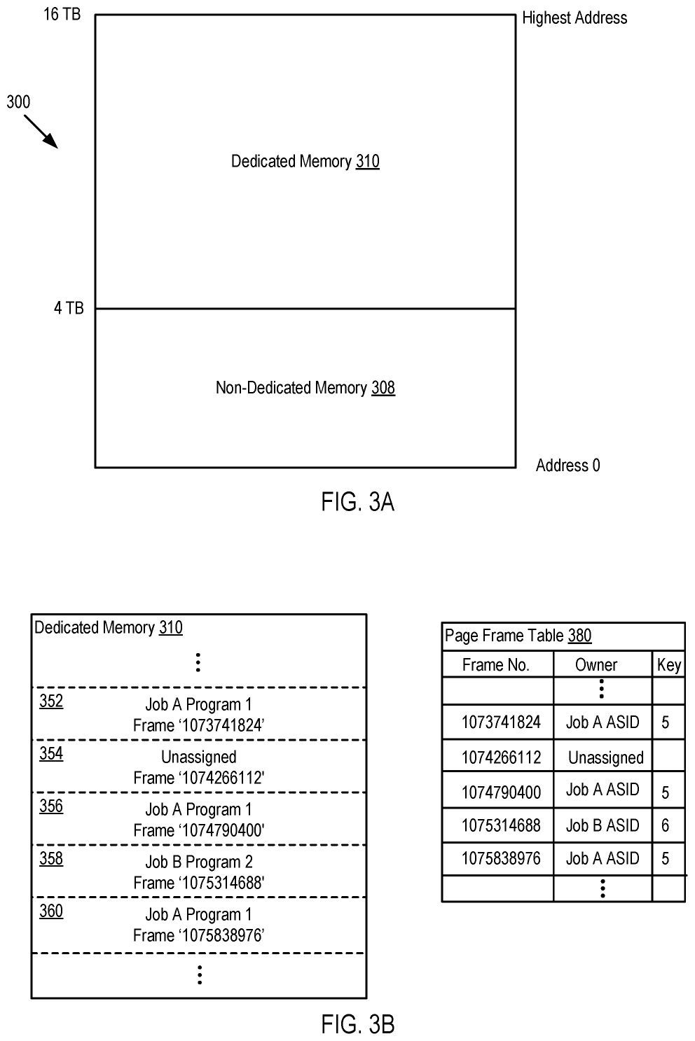

For further reference, FIG. 3A sets forth a block diagram of an example memory configuration 300 for presetting the memory protection key in dedicated memory in accordance with some embodiments of the present disclosure. The example memory configuration 300 includes 16 terabytes (TB) of system memory. The lower 4-TB includes, beginning at the highest address in the lower 4-TB, a non-dedicated memory area 308. An area of dedicated memory 400 begins at the highest memory address and occupies the upper 12 TB of system memory.

For further reference, FIG. 3B sets forth a block diagram of an example memory configuration for presetting the memory protection key in dedicated memory in accordance with some embodiments of the present disclosure. The example memory configuration includes an area of dedicated memory 310 from which a job step program 1 of job A is assigned three units of dedicated memory: a first units 352 beginning at frame number ‘1073741824’, a second unit 356 beginning at frame number ‘1074790400’, and a third unit 360 beginning at frame number ‘1075838976’. Job step program 2 of job B is assigned a fourth unit 358 of dedicated memory beginning at frame number ‘1075314688’. A fifth unit 354 beginning at frame number ‘1074266112’ is unassigned. In some examples, the dedicated memory assignments are recorded in a page frame table 380. The page frame table 380 includes, among other data, data that indicates that the frames within the units 352, 356, 360 of dedicated memory are assigned to the address space identifier (ASID) of job A and that the memory protection key of those frames is set to memory protection key ‘5’ corresponding to a program key associated with program 1. The page frame table also includes data indicates that the frames of unit 358 of dedicated memory is assigned to the ASID of job B and that the memory protection key of those frames is set to memory protection key ‘6’ corresponding to a program key associated with program 2. Although the example page frame table 380 in FIG. 3B, for ease of illustration, is shown with entries only the initial frame numbers within the units of dedicated memory, it should be appreciated that the page frame table 380 may include an entry for each individual frame.

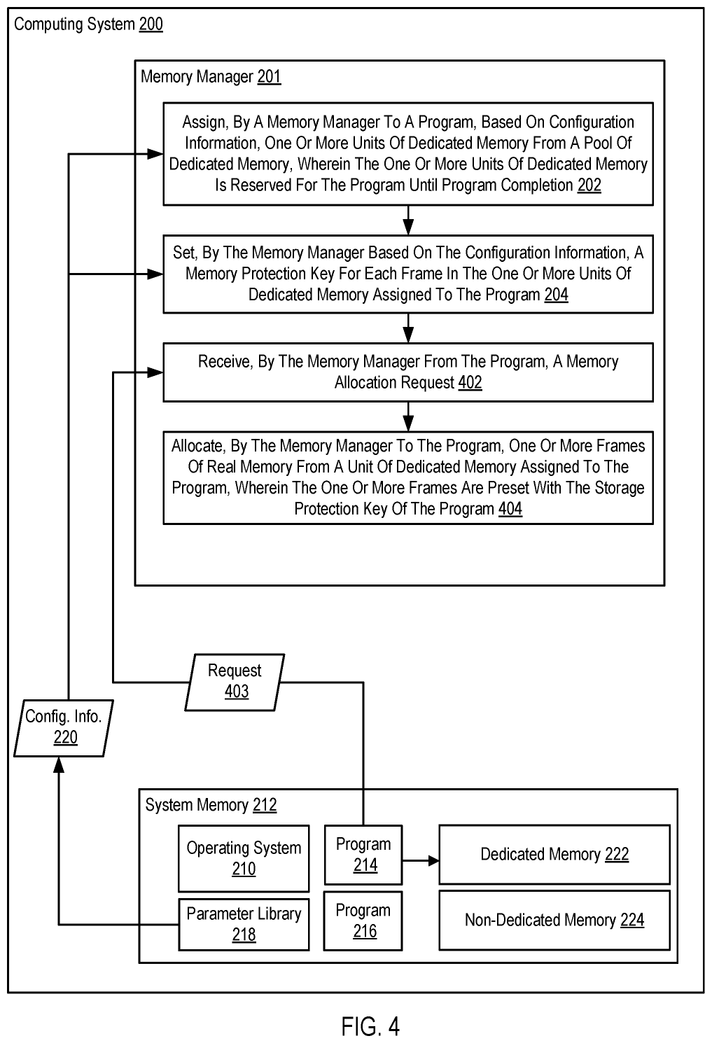

Once the program has initialized and received an assignment of dedicated memory, that program can begin using the dedicated memory. For further reference, FIG. 4 sets forth a flow chart of another example method of presetting the memory protection key in dedicated memory in accordance with some embodiments of the present disclosure. The method of FIG. 4 extends the method of FIG. 2 in that the method of FIG. 4 further includes receiving 402, from the program 214, a memory allocation request 403. In some examples, the memory manager 201 receives a request 403 from the program 214 to allocate a memory object such as a page.

The method of FIG. 4 also includes allocating 404, by the memory manager 201 to the program 214, one or more frames of real memory from a unit of dedicated memory assigned to the program, wherein the one or more frames are preset with the storage protection key of the program. In the Z/Architecture, the setting of the key is performed by the SSKE instruction which does not have good performance. In some examples, the memory manager 201 compares the size of the memory object that is requested and compares the amount request to the amount of available dedicated memory in the assigned portion of dedicated memory. The memory manager 201 allocates the memory object from dedicated memory when there is sufficient dedicated memory available in the assigned portion of dedicated memory. For example, the memory manager 201 may allocate a 2-GB, 1-MB, or 4-KB frame of dedicated memory to the program from the program's assigned units of dedicated memory. The frame(s) of dedicated memory allocated to the program are preset with the memory protection that was indicated in the configuration information 220. For example, the memory protection key corresponds to the program key of the program 214. If the memory protection code associated with the frame(s) matches the program key of the requesting program, the memory manager 201 does not need to set the memory protection key. Thus, the speed with which real memory frames can be assigned to the program is increased because the memory manager 201 does not need to set the memory protection key at the time when the virtual memory is backed (e.g., faulted on) while the program is currently executing, thereby increasing the performance of the program.

In a particular example using the z/Architecture, DUMPSRV is a program that captures a system state when a program abnormally ends. For the dump capture to accurately reflect the system state, the memory dump should be captured as quickly as possible. Thus, DUMPSRV is assigned dedicated memory to increase the performance of the dump capture and guarantee that there will be enough memory to capture the system state. DUMPSRV always executes in system key, or key ‘0.’ To further increase the performance of DUMPSRV, every frame of dedicated memory that is assigned to DUMPSRV is set to key ‘0.’ When DUMPSRV executes in response to an abnormal end, real memory frames are allocated to DUMPSRV from the dedicated memory assigned to DUMPSRV. Those real memory frames are already set to key ‘0’ before they are requested by DUMPSRV. In such instances, the DUMPSRV will not incur the performance penalty related to setting the memory protection key of those frames at the time of allocation.

It should be appreciated that, although the frames of dedicated memory are preset with a memory protection key, the program can still use conventional interfaces to change the memory protection key when requesting frames of memory to back a memory object. In such instances, the program will incur the performance penalty related to setting the memory protection key of those frames at the time of allocation.

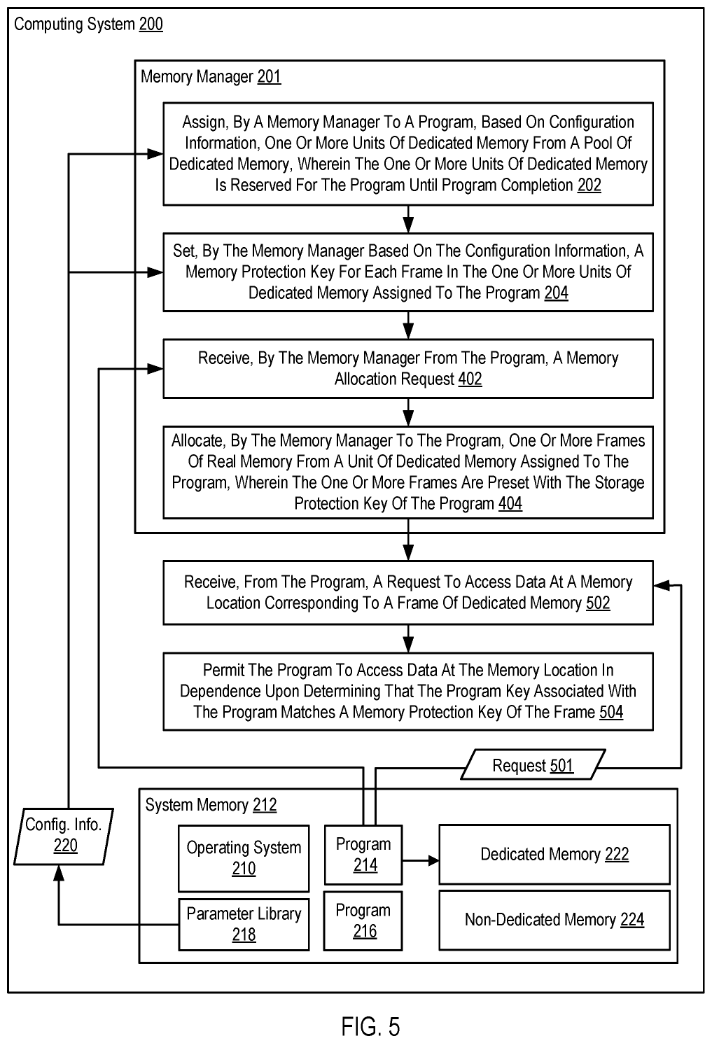

For further reference, FIG. 5 sets forth a flow chart of another example method of presetting the memory protection key in dedicated memory in accordance with some embodiments of the present disclosure. The method of FIG. 5 extends the method of FIG. 4 in that the method of FIG. 5 further includes receiving 502, from the program, a request 501 to access data at a memory location corresponding to a frame of dedicated memory. For example, the request may be a request to write to a virtual memory address. In such an example, the memory manager 201 translates the virtual memory address to a frame of real memory that backs the virtual address using, for example, a page frame table. In some cases, the frame of real memory may be a frame of dedicated memory.

The method of FIG. 5 further includes permitting 504 the program to access data at the memory location in dependence upon determining that the program key associated with the program matches a memory protection key of the frame. The page frame table includes the memory protection key for the frame of real memory associated with the request. If the memory protection key for the frame of real memory matches the program key of the program making the request, the program is permitted to read from and/or write to the frame. For example, the program key may be a component of the PSW of the program.

In view of the explanations set forth above, readers will recognize a number of advantages of presetting the memory protection key in dedicated memory according to embodiments of the present disclosure including:
programs compete less for memory when assigned with dedicated memory that is reserved for the program until completion, thus increasing program and system performance;
memory key-based protection codes limit what programs can write to particular memory locations;
setting the memory key protection code at the time of dedicated memory assignment reduces the number of processor cycles consumed by memory allocation during program execution, thus increasing program and system performance.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
assigning, by a memory manager to a program, based on configuration information, one or more units of dedicated memory from a pool of dedicated memory, wherein the one or more assigned units of dedicated memory is reserved for the program until program completion; and
setting, by the memory manager based on the configuration information, a memory protection key for each frame in the one or more units of dedicated memory assigned to the program.

2. The method of claim 1, wherein the pool of dedicated memory is located in system memory in an area that is separate from a shared memory area.

3. The method of claim 1, wherein the pool of dedicated memory is physical memory.

4. The method of claim 1, wherein the one or more units of dedicated memory is assigned and the memory protection key is set before receiving a memory allocation request from the program.

5. The method of claim 1, wherein the one or more units of dedicated memory is assigned and the memory protection key is set during system initialization.

6. The method of claim 1, wherein the configuration information indicates at least one of a minimum amount of dedicated memory and a target amount of dedicated memory.

7. The method of claim 1, wherein the configuration information indicates the memory protection key.

8. The method of claim 1, wherein the configuration information is stored in a parameter library that is read by the memory manager.

9. The method of claim 1, wherein a program assignment and memory protection key for each frame of dedicated memory in the pool of dedicated memory is recorded in a page frame table.

10. The method of claim 1 further comprising:
receiving, by the memory manager from the program, a memory allocation request; and
allocating, by the memory manager to the program, one or more frames of real memory from a unit of dedicated memory assigned to the program, wherein the one or more frames are preset with the memory protection key of the program.

11. The method of claim 10 further comprising:
receiving, from the program, a request to access data at a memory location corresponding to a frame of dedicated memory; and
permitting the program to access data at the memory location in dependence upon determining that the program key associated with the program matches a memory protection key of the frame.

12. An apparatus comprising:
a processing device; and
memory operatively coupled to the processing device, wherein the memory stores computer program instructions that, when executed, cause the processing device to:
assign, to a program based on configuration information, one or more units of dedicated memory from a pool of dedicated memory, wherein the one or more units of dedicated memory is reserved for the program until program completion; and
set, based on the configuration information, a memory protection key for each frame in the one or more units of dedicated memory assigned to the program.

13. The apparatus of claim 12, wherein the pool of dedicated memory is located in system memory in an area that is separate from a shared memory area.

14. The apparatus of claim 12, wherein the pool of dedicated memory is physical memory.

15. The apparatus of claim 12, wherein the one or more units of dedicated memory is assigned and the memory protection key is set before receiving a memory allocation request from the program.

16. The apparatus of claim 12, wherein the configuration information indicates at least one of a minimum amount of dedicated memory and a target amount of dedicated memory.

17. The apparatus of claim 12, wherein the configuration information indicates the memory protection key.

18. The apparatus of claim 12, wherein the configuration information is stored in a parameter library that is read by a memory manager.

19. The apparatus of claim 12, wherein the memory stores computer program instructions that, when executed, cause the processing device to:
receive, from the program, a memory allocation request; and
allocate, to the program, one or more frames of real memory from a unit of dedicated memory assigned to the program, wherein the one or more frames are preset with the memory protection key of the program.

20. A computer program product comprising a computer readable storage medium, wherein the computer readable storage medium comprises computer program instructions that, when executed:
assign, to a program based on configuration information, one or more units of dedicated memory from a pool of dedicated memory, wherein the one or more units of dedicated memory is reserved for the program until program completion; and
set, based on the configuration information, a memory protection key for each frame in the one or more units of dedicated memory assigned to the program.
